(19) United States
(12) Patent Application Publication
(10) Pub. No.: US 2005/0238765 A1
(43) Pub. Date: Oct. 27, 2005

(54) Flexible carbonated beverage pouch

(76) Inventors: Rodney M. Weaver, Florence, SC (US); David E. McKnight, Florence, SC (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 10/831,565

(22) Filed: Apr. 23, 2004

(51) Int. Cl. C12C 1/027

(52) U.S. Cl. 426/106

(57) ABSTRACT

A flexible pouch for a carbonated beverage is described. The pouch includes a bottom panel sealed to vertically extending front and rear panels. The front and rear panels are formed from a pressure resistant flexible material and are connected at vertical side edges and a top edge. A fitment is sealed between the top edges of the front and rear panels. The pressure resistant flexible material includes a high strength sealing layer, a gas barrier layer, and a pressure containment layer, preferably of laminated construction. The high strength sealing layer is formed from a material that can form heat seals capable of withstanding 620 kilopascals of internal pouch pressure, such as cast polypropylene and cross-linked polyethylene. The pouch can also include side panels that can be sealed to the vertical side edges of the front and rear panels by fin seals to connect the front and rear panels.

### FIELD OF THE INVENTION

The invention relates to the field of beverage packaging, and particularly to containers for carbonated beverages.

### BACKGROUND OF THE INVENTION

Carbonated beverages include those that are carbonated by fermentation, such as beer, by natural absorption of carbon dioxide under high pressure, such as spring or mineral water, or by artificial carbonation, such as soft drinks. Traditional single-serve packaging for carbonated beverages includes glass bottles and aluminum or bi-metal cans. Prior to the popular use of single-serve beverage containers, beer, for example, was principally transported and stored for moderate terms in kegs. The packaging of beer in glass bottles, in conjunction with new sterilization techniques, allowed bottlers to extend the shelf life of their products and extend their distribution networks dramatically. Bottles were also the preferred containers for soft drinks, which were first produced as artificial mineral and soda waters in the late eighteenth century, and have gained popularity ever since.

The development of metal cans for beverage packaging reduced costs and further enhanced the transportability of packaged beverages. Beer was packaged in flat top metal cans developed by the American Can Company as early as the 1930's. Experiments with the use of cans for packaging soda also began in the latter half of that decade. The packaging of carbonated beverages in cans was not without challenges. The strength of the can had to be adequate to withstand the pressure exerted by evolved gas from the carbonated beverage. In addition, the problem of the metal can ruining the taste of the beverage had to be overcome. Beer, for example, was found to have strong affinity for metal and can precipitate salts. Soda bottled in early cans were thought to take on the taste of steel. Over the years, can liners and new metals have been used to alleviate these problems.

More recently, polyethylene terephthalate (“PET”) or other plastic bottles have largely replaced glass bottles in many markets. Like other advances in carbonated beverage packaging, the use of PET bottles has served to further reduce the cost of packaging, storing and shipping, without significant sacrifice in product shelf life or container durability.

Glass bottles, metal cans and PET containers share the disadvantage of being substantially rigid. Despite significant investment in developing recycling techniques for glass, metal and PET containers, and further efforts in educating the public with regard to recycling, the majority of all such containers ultimately ends up in land-fills. Some of the containers are crushed or otherwise compacted prior to disposal. However, the containers are often disposed of in a non-compacted state, thereby consuming precious volume in the landfill. Therefore, a self collapsing container, which is also economical to produce, is needed.

Prior attempts have been made at providing flexible containers for carbonated beverages. However, prior flexible containers are limited in the amount of internal pressure they can contain. If too much pressure builds within the container, such as by evolution of carbon dioxide, the package seals can burst or leaks can develop, thereby limiting the shelf life of the product or rendering it wholly unsuitable for consumption. Attempts to alleviate this problem include enclosing the flexible container in a rigid box or shell. However, this approach requires the provision of a distinct packaging unit and ultimately does not dispense with the problem of a rigid container that requires disposal.

### SUMMARY OF THE INVENTION

The invention relates to a flexible, resealable carbonated beverage pouch formed from a pressure resistant flexible material. The pouch includes a bottom panel sealed to vertically extending front and rear panels. The front and rear panels are connected at vertical side edges and a top edge. At least the front and rear panels include a high strength sealing layer, a gas barrier layer and a pressure containment layer, preferably of laminated construction. The high strength sealing layer is formed from a thermoplastic material that can, under appropriate sealing conditions, form heat seals capable of withstanding 620 kilopascals of internal pouch pressure, such as cast polypropylene and cross-linked polyethylene.

The pouch can also include side panels that can be sealed to the vertical side edges of the front and rear panels by fin seals to connect the front and rear panels. The pouch includes a fitment that can be used to fill the pouch with a carbonated beverage and, once purchased by a consumer, can be used to reseal the pouch after some of the beverage has been consumed. The fitment can be incorporated into the pouch by sealing the fitment between the top edges of the front and rear panels.

### BRIEF DESCRIPTION OF THE DRAWINGS

For the purpose of illustrating the invention, there are shown in the drawings forms which are presently preferred; it being understood, that this invention is not limited to the precise arrangements and instrumentalities shown.

FIG. 1 is a perspective view of a flexible carbonated beverage pouch according to an embodiment of the invention.

FIG. 2 is a perspective view of a flexible carbonated beverage pouch according to another embodiment of the invention.

FIG. 3 is a perspective view of a flexible carbonated beverage pouch according to yet another embodiment of the invention.

FIG. 4 is a schematic cross-sectional view of a pressure resistant flexible material for making a carbonated beverage pouch according to the various embodiments of the invention.

FIG. 5 is a schematic cross-sectional view of another pressure resistant flexible material for making a carbonated beverage pouch according to the various embodiments of the invention.

### DETAILED DESCRIPTION OF THE DRAWINGS

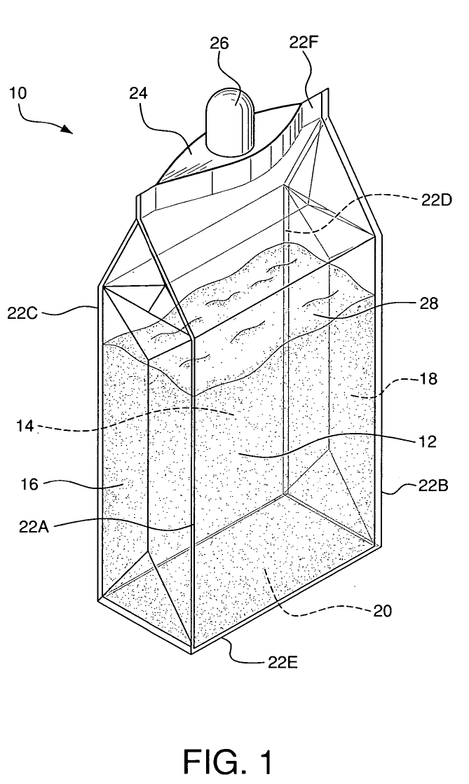

In the Figures, in which like reference numerals indicate like elements, there are shown embodiments of a flexible, resealable carbonated beverage pouch and materials for making the pouch according to the present invention. FIGS. 1 through 3 show embodiments of the resealable carbonated beverage pouch. Each of the embodiments are stand-alone pouches, meaning that when filled with a carbonated beverage, each stands upright without need of a supplemental rigid support. Each embodiment is formed from a pressure resistant flexible material having a high strength sealing layer, a gas barrier layer and a pressure containment layer. Suitable pressure resistant flexible materials for forming a pouch according to the present invention are shown schematically in FIGS. 4 and 5.

A preferred pouch 10 is shown in FIG. 1. The pouch 10 can be formed from three webs of pressure resistant flexible material. The method of combining the three webs of material can be similar to that used to form pouches known as SQ4 or U-PACK-style pouches. U-PACK is a trademark of Bischof+Klein, Germany. Pouch forming machines suitable for forming such pouches are commercially available from Reinhold Machinen, Lengerich, Germany.

Two of the webs can be slit to form a front panel 12, a rear panel 14 and side panels 16, 18. The front panel 12, rear panel 14 and side panels 16, 18 of the pouch can alternatively be formed from four distinct webs. The front panel 12 is joined to the side panels 16, 18 by juxtaposing respective high strength sealing layers provided on each of the panels and forming vertical fin-type heat seals 22A, 22B. As used herein, the terms “fin seal” and “fin-type seal” are used to describe a seal between two materials that each have a sealing layer disposed on the inside of the pouch (once formed), in which the sealing layers are juxtaposed against each other and sealed under heat and pressure. In similar fashion, the rear panel 14 is sealed to the side panels 16, 18 at heat seals 22C and 22D, respectively. The third web can form the bottom panel 20 of the pouch 10. The bottom panel 20 can be similarly sealed with fin-type seals 22E to the front panel 12, rear panel 14 and side panels 16, 18. Also, the tops of the front 12 and rear 14 panels are sealed together at seal 22F.

The material of the webs used to form the front panel 12, rear panel 14 and side panels 16, 18 are selected to withstand the internal pressure associated with packaging of carbonated beverages. Suitable materials and the layers thereof are described more fully below with regard to FIGS. 4 and 5. The bottom panel 20 can also be formed from the same pressure resistant flexible material. Alternatively, the bottom panel 20 can be a rigid material. However, if rigid, it is preferred that the material of the bottom panel 20 be thermoplastic so that it can be heat sealed or thermally welded to the front 12, rear 14 and side 16, 18 panels.

A fitment is provided on the pouch 10. The fitment can be selected from a variety of fitment styles, including threaded square-type, canoe-type or round-type fitments. A threaded type fitment, such as the canoe-type fitment 24 shown in FIG. 1, is especially suited for use with carbonated beverages. The fitment 24 is provided with a resealable threaded cap 26. A resealable cap allows the beverage packager to fill the pouch with a carbonated beverage 28 through the fitment prior to engaging the cap, and also permits the user to reseal the pouch and store any unused beverage after initially opening the pouch. Threaded type fitments can be vented in similar fashion to the neck and cap of certain known PET soda bottles. However, other fitment styles, such as pop tops or hinged fitments could also be used.

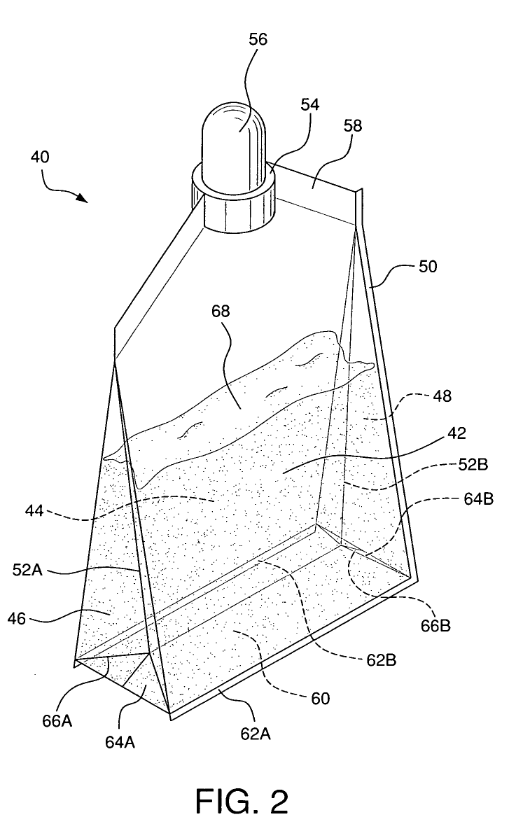

A pouch with four corner seals, such as the pouch 10, is presently preferred because in this configuration, the panels distribute the force of the internal pouch pressure. As such, the pouch can withstand higher internal pressure than beverage pouches of presently known configurations. Thus, the configuration of pouch 10 minimizes the risk of rupture or other mechanical failure. A pouch with similar advantages can be achieved by forming the pouch 10 from a main web, which need not be slit, and a bottom web. The main web can form all four vertical sides and be sealed at one corner, similar to that described below with regard to FIG. 2. Fabrication technology for making a pouch from a main web and a bottom web is available from Totani Corporation, Kyoto, Japan.

FIG. 2 shows another embodiment of a carbonated beverage pouch according to the present invention. The pouch 40 includes a front panel 42, a rear panel 44, and side panels 46, 48, which can be formed from a single web of pressure resistant flexible material. The web can be formed into a tube and the opposed opposite edges sealed with a fin-type seal 50. The sides of the tube can be plowed in to form side gussets 52A, 52B. The top of the front 42 and rear 44 panels can be cut to form inclines with a central apex. The apex is provided with a threaded round-type fitment 54 equipped with a screw cap 56. The fitment 54 is sealed into the top of the pouch by a heat seal 58 sealing the top edges of the front panel 42 and rear panel 44.

The top of the pouch can alternatively be formed in the shape of an arc, with the fitment 54 disposed at the top of the arc. In that case, the heat seal 58 follows the shape of the arc along the top edge. Such an arcuately formed top edge can further help withstand internal pressure produced by a carbonated beverage.

The bottom panel 60 can be formed from a second web of pressure resistant flexible material. The bottom panel can be sealed to the front 42 and rear 44 panels by fin-type heat seals 62A and 62B, respectively. The bottom panel 60 is sealed to the side panels 46, 48 by heat sealing a triangular surface 64A, 64B at each lateral edge of the bottom panel 60 to the inside of each of the side gussets 52A, 52B. The entire area of triangular surfaces 64A, 64B can be heat sealed, or the seal can be made only along heat seal lines 66A, 66B. Alternatively, a heat sealable or thermally weldable rigid material can be used to form the bottom panel 60. The pouch 40 can be filled with a carbonated beverage 68 through the fitment 54.

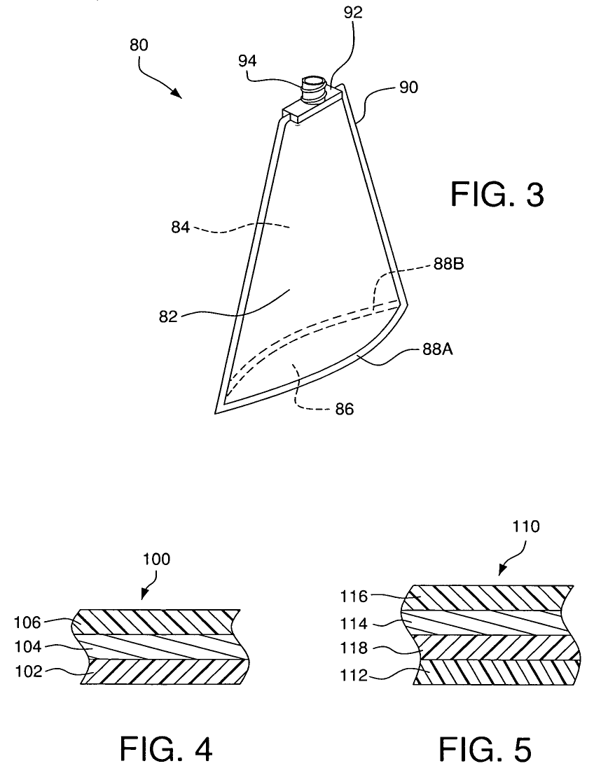

A third embodiment of a flexible pouch formed from a pressure resistant flexible material is shown in FIG. 3. This embodiment can be formed from a single web or up to three webs. The pouch 80 is formed with a front panel 82, a rear panel 84 and a bottom panel 86. The edges of the bottom panel are folded downwardly and sealed to the front 82 and rear 84 panels along heat seals 88A, 88B, respectively. The front 82 and rear 84 panels are sealed to each other along heat seal 90. The heat seal 90 extends along the sides and around the top of the front 82 and rear 84 panels and seals a fitment 92 in place near the top of pouch 80. The fitment 92 is a rectangular-type fitment. The corresponding cap is not shown so that threads 94 can be seen.

An embodiment of the pressure resistant flexible material for forming one or more panels of a pouch according to the present invention is shown schematically in FIG. 4. The material 100 includes a high strength sealing layer 102, a gas barrier layer 104 and a pressure containment layer 106. The layers are preferably laminated with a suitable adhesive. However, if appropriate materials are selected in accordance with the guidelines below, the pressure resistant flexible material can alternatively be formed by extrusion coating the high strength sealing layer 102 or the pressure containment layer onto the gas barrier layer, by coating or depositing the gas barrier layer onto the high strength sealing layer 102 or pressure containment layer 106, or by coextruding two or more of the layers.

The high strength sealing layer 102 is formed from a thermoplastic resin capable of forming heat seals that can withstand the internal pressure produced by carbonated beverages to be contained within the pouch under expected conditions of normal use. Such a seal is preferably capable of withstanding about 620 kilopascals (about 90 pounds per square inch) of internal pressure in an ambient environment of 100 kilopascals (about 1 atmosphere) at typical storage temperatures. Suitable materials include cast polypropylene (“CPP”) and cross-linked polyethylene, CPP being preferred. Suitable CPP film is commercially available form Tredegar Corporation of Richmond, Va. Cross-linked polyethylene film is commercially available from Cryovac, Inc. of Duncan, S.C.

The high strength sealing layers of two webs or opposed edges of a single web are brought together in fin-type sealing configuration and heat sealed between sealing jaws under pressure at relatively high temperatures in order to form the seals of the various pouch embodiments described above. Appropriate sealing temperatures include 140-150 degrees C. if CPP is the high strength sealing layer, and 135-145 degrees C. for cross-linked polyethylene. Sealing can be preformed under pressure of about 275 kilopascals (about 40 pounds per square inch) using a dwell time of about one second. Higher temperatures can be used if shorter dwell times are desired.

The gas barrier layer 104 is preferably a metal foil, such as aluminum foil. Foil can retard inflow of oxygen into the package to alleviate spoilage. In addition, foil can retard loss of carbon dioxide or other carbonating fluid from the pouch. As such, the partial pressure of the carbonating fluid within the pouch will build up, thereby slowing further loss of carbonating fluid from the carbonated beverage contained within the pouch. The gas barrier layer 104 serves to keep the product fresh, as well as maintain the desired level of carbonation within the beverage.

When the high barrier properties of foil are not required, the gas barrier layer 104 can alternatively be formed by metallizing a target film, which can be the high strength sealing layer 102, the pressure containment layer 106 or another film to be included therebetween. Metallizing the target film can be performed by vacuum depositing a layer of aluminum or other metal onto the target film. Another alternative to foil, if high barrier properties are not necessary, is to provide an inorganic oxide coating, such as Al₂O₃ or SᵢO_{χ}, on the target film. Other alternative barrier coatings can include organic coatings, polyvinylidene chloride or the like. Such a metal layer or barrier coating should be provided on a major surface of the target film that is ultimately in contact with another layer of the pressure resistant flexible material so that the alternative barrier layer is protected from physical damage.

The pouch 10 and the pouch 40 are shown as transparent in FIGS. 1 and 2 so that a carbonated beverage and the rearward and bottom structures of the pouches can be seen. It is possible for the pouches to be transparent if appropriate materials are chosen for the high strength sealing layer and pressure containment layer and if one or more transparent coatings, some of which are listed above, are used as the gas barrier layer. However, if the high barrier properties provided by a foil layer are required, the pouch will be opaque, as shown in FIG. 3.

The pressure containment layer 106 is a material capable of protecting the gas barrier layer 104 from puncture and abrasion damage, as well as capable of resisting rupture due to pressure within the pouch produced by the carbonated beverage. Such materials should resist stretching and rupture when influenced by the internal pressure noted above. The pressure containment layer is preferably a thermoplastic layer, such as polyester, PET being especially preferred. Other materials that can be used to form the pressure containment layer include mono or biaxially oriented nylon, oriented high density polyethylene (“HDPE”), oriented polypropylene (“OPP”) and polyethylene napthalate (“PEN”).

FIG. 5 schematically shows another pressure resistant flexible material 110. The material 110 includes a high strength sealing layer 112, a gas barrier layer 114, a pressure containment layer 116 and a reinforcing layer 118. The high strength sealing layer 112, the gas barrier layer 114 and the pressure containment layer 116 can be formed from the same materials as the high strength sealing layer 102, the gas barrier layer 104 and the pressure containment layer 106 of the embodiment of FIG. 4, respectively.

The reinforcing layer 118 adds additional strength to the structure, thereby permitting the material 110 to withstand greater internal pouch pressure. A preferred material for the reinforcing layer 118 is nylon, such as nylon 6. However, other materials, particularly oriented materials, can instead be used.

A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

1. A flexible carbonated beverage pouch comprising:
a bottom panel sealed to vertically extending front and rear panels, each of the front and rear panels having vertical side edges and a top edge, the front and rear panels being connected at the vertical side edges and top edges;
at least the front and rear panels being of laminated construction comprising, in order,
a high strength sealing layer comprising a material selected from the group consisting of cast polypropylene and cross-linked polyethylene,
a gas barrier layer, and
a pressure containment layer; and
a fitment sealed between the top edges of the front and rear panels.

2. The flexible carbonated beverage pouch of claim 1 further comprising side panels connecting the vertical side edges of the front and rear panels.

3. The flexible carbonated beverage pouch of claim 1 wherein the front and rear panels further comprise a reinforcing layer disposed between the high strength sealing layer and the gas barrier layer.

4. The flexible carbonated beverage pouch of claim 3 wherein the reinforcing layer is nylon.

5. The flexible carbonated beverage pouch of claim 1 wherein the gas barrier layer is a metal foil.

6. The flexible carbonated beverage pouch of claim 1 wherein the pressure containment layer is PET.

7. The flexible carbonated beverage pouch of claim 1 further comprising a carbonated beverage disposed within the pouch.

8. A flexible carbonated beverage pouch comprising:
a bottom panel sealed to flexible, vertically extending front, rear and side panels by fin seals, each of the front and rear panels having vertical side edges and a top edge, the vertical side edges of the front and rear panels being sealed to the side panels by fin seals;
a fitment sealed between the top edges of the front and rear panels; and
a carbonated beverage disposed within the pouch.

9. The flexible carbonated beverage pouch of claim 8 wherein the front, rear and side panels are of a laminated construction comprising, in order
a high strength sealing layer,
a gas barrier layer, and
a pressure containment layer.

10. The flexible carbonated beverage pouch of claim 9 wherein the high strength sealing layer comprises a material selected from the group consisting of cast polypropylene and cross-linked polyethylene.

11. The flexible carbonated beverage pouch of claim 9 wherein the front, rear and side panels further comprise a reinforcing layer disposed between the high strength sealing layer and the gas barrier layer.

12. The flexible carbonated beverage pouch of claim 11 wherein the reinforcing layer comprises nylon.

13. The flexible carbonated beverage pouch of claim 9 wherein the fin seals between the side panels and the respective front and rear panels comprise heat sealed points of contact between the high strength sealing layers of the front and rear panels, respectively, and the high strength sealing layers of the side panels.

14. A method of packaging a carbonated beverage comprising the steps of:
providing a pressure resistant flexible material having a high strength sealing layer;
forming front and rear panels having vertical side edges and top edges from the material;
connecting the vertical side edges with fin seals by heat sealing the high strength sealing layers at a temperature of about 135 degrees C. or more;
attaching the front and back panels to a bottom panel;
sealing the top edges of the front and rear panels, with a fitment between the top edges, to form a pouch; and
filling the pouch with a carbonated beverage through the fitment.

15. The method of claim 14 wherein the step of connecting the vertical side edges comprises the steps of interposing side panels between the vertical side edges of the front and rear panels and forming heat seals between each of the vertical side edges and an edge of one of the side panels.

16. The method of claim 14 wherein the step of connecting the vertical side edges comprises the steps of juxtaposing the high strength sealing layers of the vertical side edges and forming a heat seal between the juxtaposed high strength sealing layers.
